(19) United States
(12) Patent Application Publication
(10) Pub. No.: US 2014/0335494 A1
(43) Pub. Date: Nov. 13, 2014

(54) SYSTEMS AND METHODS FOR FACILITATING COACHING AND/OR ANALYSIS OF PRESSURE-BASED TREATMENT

(71) Applicant: EZ AS A DRINK PRODUCTIONS, INC., Venice, CA (US)

(72) Inventors: Kostadin Dimitrov Yanev, Alamo, CA (US); Ivo Kostadinov Yanev, Sofia (BG); Angel Georgiev Vassilev, Sofia (BG)

(73) Assignee: EZ AS A DRINK PRODUCTIONS, INC., Venice, CA (US)

(21) Appl. No.: 13/890,109

(22) Filed: May 8, 2013

(51) Int. Cl. G09B 19/00

(52) U.S. Cl. CPC G09B 19/00
USPC 434/262

(57) ABSTRACT

Coaching and/or analysis of pressure-based treatment may be facilitated by a handheld treatment device. A force exerted on a body part of a subject may be quantified. The force may be exerted by a force exerting object (e.g., a hand) on the treatment device disposed between the force exerting object and the body part of the subject. The force may be applied as the pressure-based treatment. A position of the body part on the body of the subject may be determined based on the position of the treatment device relative to the body of the subject. Various parameters associated with the pressure-based treatment may be determined. Instructions associated with the pressure-based treatment may be provided via the treatment device. A given instruction may relate to a magnitude of the exerted force and/or a position on the body of the subject where the force is to be applied.

### FIELD OF THE INVENTION

The invention relates to systems and methods for facilitating coaching and/or analysis of pressure-based treatment.

### BACKGROUND OF THE INVENTION

Pressure-based treatment may include massage, kneading or rubbing of body parts, acupressure, and/or other types of pressure-based treatment, therapy, and/or regimen. Pressure-based treatment techniques generally may include a certain action (e.g., rubbing, pressing, and/or other actions) being performed with a specific pressure on a specific location of a subject's body. Traditionally, pressure-based treatment techniques are learned by in-person demonstration by an instructor or by video of the same.

### SUMMARY

One aspect of the invention relates to a system configured to facilitate coaching and/or analysis of pressure-based treatment, in accordance with one or more implementations. The system may include a treatment device. The treatment device may be a handheld electronic device. The treatment device may be used to provide a pressure-based treatment to a subject. The pressure-based treatment may be provided by the subject himself or by a treatment provider. In exemplary implementations, during pressure-based treatment, the treatment device may be disposed between a body part of the subject and a force exerting object such that a force exerted by the force exerting object is conveyed to the body part of the subject wholly or partially via the treatment device. For example, the treatment provider may hold the treatment device in an open hand and place the other side of treatment device on the body of the subject such that when the treatment provider presses on the treatment device an equal force is applied to the body of the subject. As further examples, the force exerting object may include one or more of a foot of the treatment provider, an accessory manipulated by the treatment provider, a hand of the subject, an accessory manipulated by the subject, and/or other force exerting objects.

The treatment device may be configured to determine one or more parameters associated with a pressure-based treatment. Examples of such parameters may include one or more a duration of the exerted force, a duration of a treatment session, a type of pressure-based treatment, a direction of a motion, a rate of a motion, a force gradient, a force magnitude, a pattern of one or more parameters (e.g., motions, magnitudes, durations, and/or other parameters), and/or other parameters associated with the pressure based treatment. One or more of such parameters may be used to aid compliance with a prescribed treatment, therapy, or regimen. In some implementation, one or more of such parameters may be used as feedback for coaching purposes. That is, the treatment device may facilitate learning and/or instruction of techniques associated with pressure-based treatment.

The treatment device may include one or more of a force sensor, a position sensor, an electrical muscle stimulation (EMS) interface, an actuator, a user interface, communications apparatus, a power supply, electronic storage, a processor, and/or other components. One or more components of the treatment device may be housed by one or more housing bodies. The force sensor may be configured to generate a force output signal that conveys information related to compressive force exerted on the treatment device. The position sensor may be configured to generate a position output signal conveying information related to a position of the treatment device relative to the body of the subject. The actuator may be configured to provide vibrational therapy to the subject by vibrating the treatment device.

The treatment device may be configured to execute computer program modules. The computer program modules may include one or more of a presentation module, a voice command module, a force quantification module, a position determination module, a treatment analysis module, a treatment coaching module, a backup module, an update module, and/or other computer program modules.

The presentation module may be configured to present, via the user interface, information associated with the system. Such information may be presented visually, audibly, textually, haptically, and/or other presentation manners. According to some implementations, the presentation module may be configured to present information derived from a force output signal provided by the force sensor, information derived from a position output signal provided by the position sensor, information associated with pressure-based treatment, and/or other information associated with the system.

The voice command module may be configured to receive voice commands and initiate corresponding operations based on the received voice commands. In some implementations where the user interface of the treatment device includes a microphone, the voice command module may be configured to receive audio information captured by the microphone that includes a voice command. The voice command module may be configured to initiate, responsive to reception of the audio information including the voice command, an operation by the one or more processors corresponding to the voice command in the received audio information. The voice command module may utilize one or more of speech recognition, speech to text, and/or other voice-based technologies. The voice command module may be configured to identify a speaker based on the speaker's voice.

The force quantification module may be configured to quantify a force exerted on a body part of the subject. The force may be quantified based on a signal conveying information associated with the exerted force (e.g., the force output signal generated by the force sensor). Quantifying the force may include quantifying one or more of a magnitude of force, a duration of force, a force magnitude profile as a function of time, a quantity of compressive forces, and/or other quantifiable information associated with forces exerted on the body of the subject.

The position determination module may be configured to determine a position of the body part on the body of the subject on which a force is applied. The position determination may be based on a signal conveying information associated with the position of the treatment device relative to the body of the subject (e.g., the position output signal generated by the position sensor). By way of non-limiting example, the position determination module may determine that a force was applied (by way of the treatment device) to a rhomboid, trapezius, or other muscle group of the subject. The position determination module may be configured to determine position and a function of time.

The treatment analysis module may be configured to determine one or more parameters associated with the pressure-based treatment. Examples of such parameters may include one or more of a duration of the exerted force, a duration of a treatment session, a type of pressure-based treatment, a direction of a motion, a rate of a motion, a force gradient, a force magnitude, a pattern of one or more parameters (e.g., motions, magnitudes, durations, and/or other parameters), and/or other parameters associated with the pressure-based treatment.

The treatment coaching module may be configured to provide one or more instructions associated with the pressure-based treatment. A given instruction may relate to one or more of a magnitude of the exerted force, a position on the body of the subject where the force is to be applied, and/or other aspects of a pressure-based treatment. Instructions may be conveyed one or more of audibly, visually, textually, haptically (e.g., by vibration and/or other haptic feedback), and/or in other manners. Instructions may be stored in the system. The instruction may be provided as a series of lessons on pressure-based treatment. In some implementations, instructions may be provided by a remote source. For example, instructions may be provided by a remotely located instructor. The treatment coaching module may be configured to provide feedback associated with a pressure-based treatment that is being performed and/or that was performed in the past. Such feedback may comprise a critique of the pressure-based treatment.

The backup module may be configured to back up information stored by the treatment device. Information stored by the treatment device may be transmitted to a remote electronic storage configured to electronically store information. The backup module may be configured to perform a backup according to a schedule, responsive to a command received from a user, responsive to information being stored by the treatment device, responsive to the treatment device becoming communicatively coupled with a personal computing platform and/or a personal wellness platform server, and/or based on other criteria.

The update module to manage updates of software and/or firmware of the treatment device. Software updates and/or firmware updates may be transmitted from a personal computing platform, a treatment platform server, and/or other components of the system. Software updates and/or firmware updates may be received by the treatment device. Software updates and/or firmware updates may be implemented on a processor and/or other components of the treatment device.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate coaching and/or analysis of pressure-based treatment, in accordance with one or more implementations.

FIG. 2 illustrates an exemplary processor included in one or more components of the system, in accordance with one or more implementations.

FIG. 3 illustrates a method for facilitating coaching and/or analysis of pressure-based treatment, in accordance with one or more implementations.

### DETAILED DESCRIPTION

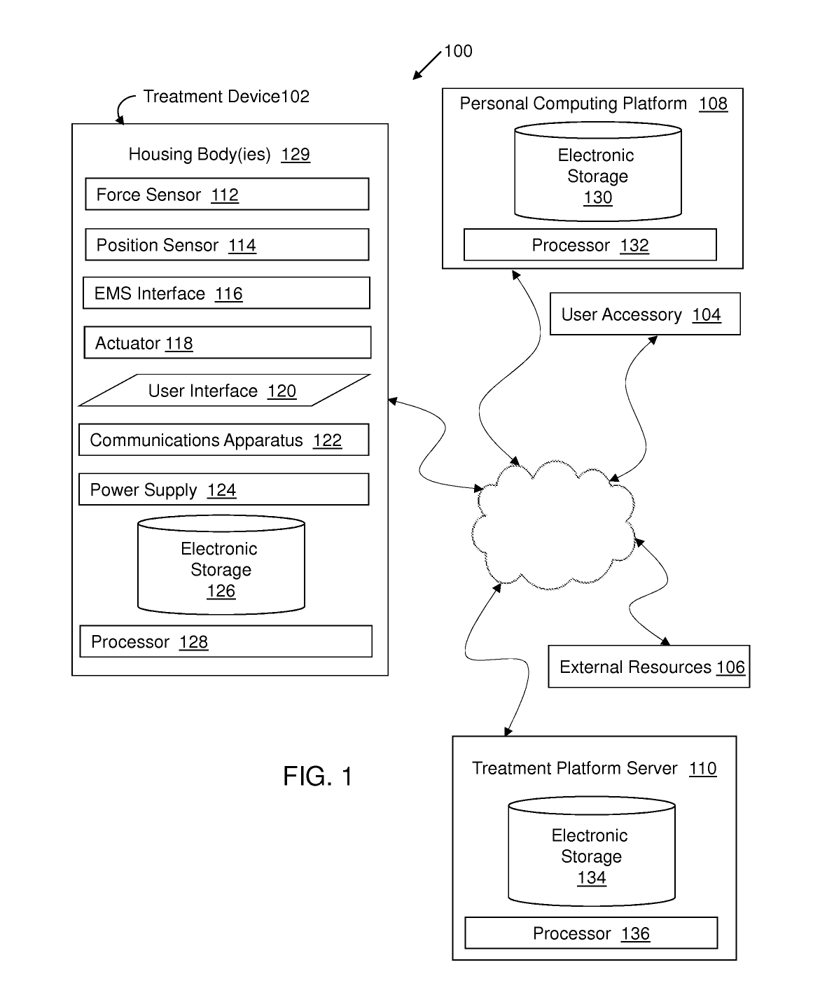

FIG. 1 illustrates a system 100 configured to facilitate coaching and/or analysis of pressure-based treatment, in accordance with one or more implementations. The system 100 may include a treatment device 102. The treatment device 102 may be a handheld electronic device. The treatment device 102 may be used to provide a pressure-based treatment to a subject. The pressure-based treatment may be provided by the subject himself or by a treatment provider. In exemplary implementations, during pressure-based treatment, treatment device 102 may be disposed between a body part of the subject and a force exerting object such that a force exerted by the force exerting object is conveyed to the body part of the subject wholly or partially via treatment device 102. For example, the treatment provider may hold treatment device 102 in an open hand and place the other side of treatment device on the body of the subject such that when the treatment provider presses on treatment device 102 an equal force is applied to the body of the subject. As further examples, the force exerting object may include one or more of a foot of the treatment provider, an accessory manipulated by the treatment provider, a hand of the subject, an accessory manipulated by the subject, and/or other force exerting objects.

The treatment device 102 may be configured to determine one or more parameters associated with a pressure-based treatment. Examples of such parameters may include one or more a duration of the exerted force, a duration of a treatment session, a type of pressure-based treatment, a direction of a motion, a rate of a motion, a force gradient, a force magnitude, a pattern of one or more parameters (e.g., motions, magnitudes, durations, and/or other parameters), and/or other parameters associated with the pressure based treatment. One or more of such parameters may be used to aid compliance with a prescribed treatment, therapy, or regimen. In some implementation, one or more of such parameters may be used as feedback for coaching purposes. That is, treatment device 102 may facilitate learning and/or instruction of techniques associated with pressure-based treatment.

In addition to treatment device 102, system 100 may include one or more of a user accessory 104, external resources 106, a personal computing platform 108, a treatment platform server 110, and/or other components, which may complement and/or include one or more functionalities attributed herein to treatment device 102. Components of system 100, such as treatment device 102, personal computing platform 108, treatment platform server 110, user accessory 104, and/or external resources 106, may be operatively linked via one or more electronic communication links. For example, such electronic communication links may be established, at least in part, via a wired or wireless network, which may include the Internet, WiFi, LAN, Bluetooth, and/or other networks. It will be appreciated that this is not intended to be limiting, and that the scope of this disclosure includes implementations in which treatment device 102, personal computing platform 108, treatment platform server 110, user accessory 104, and/or external resources 106 are operatively linked via some other communication media.

As depicted in FIG. 1, treatment device 102 may include one or more of a force sensor 112, a position sensor 114, an electrical muscle stimulation (EMS) interface 116, an actuator 118, a user interface 120, communications apparatus 122, a power supply 124, electronic storage 126, a processor 128, and/or other components. One or more components of treatment device 102 may be housed by one or more housing bodies 129.

According to some implementations, housing body(ies) 129 may comprise two housing bodies including a first housing body and a second housing body. The first housing body and the second housing body may be movably coupled together by way of a coupling mechanism such that the two housing bodies are reconfigurable between an open configuration and a closed configuration. The two housing bodies may be configured to receive compressive force during personal exercise while in the closed configuration. The user interface 120 may be accessible with the two housing bodies in the open configuration. Exemplary implementations of a personal wellness device having two housing bodies are described in U.S. patent application Ser. No. 13/527,465, filed on Jun. 19, 2012, and entitled “Personal Wellness Device,” which is incorporated herein by reference.

The force sensor 112 may be configured to generate a force output signal that conveys information related to compressive force exerted on treatment device 102. Such information may include or be used to determine magnitude of force, duration of force, a force magnitude profile as a function of time, a quantity of compressive forces, and/or other information related to compressive force exerted on treatment device 102. The force output signal generated by force sensor 112 may be received and/or utilized by one or more modules executable by processor 128, as described further herein. By way of non-limiting example, force sensor 112 may include a FlexiForce A201 force sensor from Tekscan. However, other apparatus configured for force sensing are contemplated and within the scope of the invention.

The position sensor 114 may be configured to generate a position output signal conveying information related to a position of treatment device 102 relative to the body of the subject. The position sensor 114 may be configured to generate a position output signal that conveys information related to a position as a function of time associated with a motion and/or a change in orientation of treatment device 102. The position output signal may be used to quantify motions, changes in motion, orientation, changes in orientation, and/or information derived therefrom. By way of non-limiting example, position sensor 114 may include one or more of an accelerometer configured to generate signals conveying information related to motion and/or orientation, a GPS device configured to generate signals conveying information related to geo-location, an RFID configured to generate signals conveying information related to proximity to a reader, a trackball configured to generate signals conveying information related to motion and/or trajectory, and/or other devices and/or sensors configured to generate signals associated with position and/or motion. However, other apparatus and techniques for motion and/or orientation sensing and/or detection are contemplated and within the scope of the invention.

The electrical muscle stimulation interface 116 may be configured to removably couple treatment device 102 with an electrode. The electrode may be configured to provide electrical muscle stimulation to a subject. In some implementations, electronic pulses (or other waveforms) may be provided by electrical muscle stimulation interface 116 to the electrode, which in turn may deliver the electrical pulses to a surface area of a subject's body causing proximate muscles to exercise passively.

The actuator 118 may be configured to provide vibrational therapy to the subject by vibrating treatment device 102. Vibrational therapy may supplement a pressure-based therapy to further increase stimulation to a body part of the subject. In some implementations, actuator 118 may be configured to provide tactile feedback to a user. Tactile feedback may be preferable in some use scenarios, for example, where other feedback mechanisms such as audio or visual may be undesired. Tactile feedback may include forces, vibrations, motions, and/or other tactile feedback provided to the user. The actuator 118 may include a mechanical device configured to cause one or more motions of treatment device 102. In some implementations, actuator 118 may include an electric motor with an unbalanced mass on its driveshaft such that rotation of the driveshaft generates vibrations. One or more parameters of the tactile feedback may be varied to convey different information to a user. The parameters may include one or more of direction, source location, duration, frequency, amplitude, and/or other parameters.

The user interface 120 may be configured to receive information from a user and provide information to the user. As such, user interface 120 may include hardware and/or software to facilitate receiving information from the user and/or providing information to the user. Examples of input devices may include one or more of a touch screen, a touch pad, a keypad, a switch, an analog stick, a button, a dial, a microphone, biometric sensor, and/or other hardware configured to receive information from a user. Examples of output devices may include one or more of a display, touch screen, speakers, and/or other hardware configured to provide information to a user.

In some implementations, user interface 120 may be configured to present user configurable settings to the user. The user interface 120 may be configured to receive selections from the user of values for the user configurable settings. One or more user configurable settings may impact the current activity of one or more components of treatment device 102. By way of non-limiting example, the user configurable settings may activate and/or deactivate one or more components of treatment device 102, and/or may configure one or more aspects of operation of treatment device 102. The user configurable settings may be related to personal exercise and/or wellness of a user of treatment device 102. The user configurable settings may be provided to processor 128 of treatment device 102. The user configurable settings may be provided to one or more processors of user accessory 104, personal computing platform 108, treatment platform server 110, and/or other components of system 100.

The communications apparatus 122 may be configured to receive information and/or transmit information from treatment device 102. As such, communications apparatus 122 may include one or both of a wireless communications interface or a wired communications interface. Examples of a communications interface may include a wired or wireless transmitter, a wired or wireless receiver, and/or a combined wired or wireless transmitter and receiver. The communications apparatus 122 may be configured to communicatively couple treatment device 102 with a computing platform (e.g., personal computing platform 108 and/or treatment platform server 110) configured to receive and process information related to pressure-based treatment, a user accessory that is separate and distinct from treatment device 102, and/or other components of system 100.

The power supply 124 may be configured to supply electrical power to one or more components of treatment device 102. By way of non-limiting example, power supply 124 may include one or more of a battery, a capacitor, apparatus for receiving electrical power from an external source (e.g., a wall socket), and/or other power supplies. In some implementations, power supply 124 may be rechargeable. In one implementation, where communications apparatus 122 includes a USB port or other wired communications port, communications apparatus 122 may receive electrical power from a component of system 100 and/or another source to recharge power supply 124.

The electronic storage 126 may be configured to electronically store information. Exemplary implementations of electronic storage that is the same or similar to electronic storage 126 are described further herein.

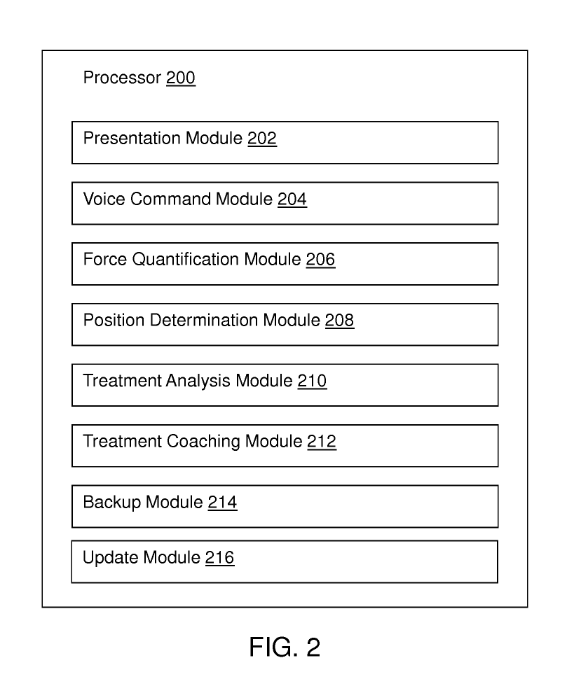

The processor 128 may be configured to execute computer program modules. Exemplary implementations of processors that are the same or similar to processor 128 are described in connection with FIG. 2.

The user accessory 104 may be configured to be physically and/or communicatively coupled with treatment device 102. The user accessory 104 may be configured extend treatment capabilities and/or functionalities of treatment device 102. In some implementations, user accessory 104 may include a trackball configured to generate signals conveying information related to motion and/or trajectory. The user accessory 104 may include a treatment-specific and/or ergonomic accessory such as, for example, accessories that provide and/or facilitate friction, punching, twisting, and/or other treatment-specific and/or ergonomic accessories. In some implementations, user accessory 104 may include a strap (not depicted in FIG. 1) or other apparatus configured for similar functionality attributed herein to the strap. Such a strap may be configured to physically couple to treatment device 102 and facilitate exertion of compressive force on treatment device 102 responsive to a tensive force exerted on the strap. The strap may be removably coupled to treatment device 102 by hooks, snaps, hook and loop fasteners, and/or other means for removable coupling. In implementations, user accessory 104 may include an electrode (not depicted in FIG. 1). In some implementations, electrical muscle stimulation interface 116 may be configured to removably couple treatment device 102 with the electrode. The electrode may be configured to provide electrical muscle stimulation to a user.

In implementations, user accessory 104 may include one or more of a wired headset; a wireless headset; wired headphones; wireless headphones; a device that includes a display; one or more sensors configured to be attached to a subject's body and provide a signal conveying information associated with motion, position, and/or other information associated with a subject; a device configured to determine subject and/or body part motion, size, and/or position (e.g., MS Kinect™); and/or other accessories configured to extend one or more functionalities of treatment device 102. A device configured to determine subkect and/or body part motion, size, and/or position may perform such determination(s) based on optical information, signals received from one or more sensors attached to a subject's body, and/or other information associated with subject.

The external resources 106 may include sources of information, hosts and/or providers of systems, external entities participating with system 100, and/or other resources. In some implementations, some or all of the functionality attributed herein to external resources 106 may be provided by resources included in system 100.

The personal computing platform 108 may include one or more of electronic storage 130, at least one processor 132, and/or other components. The electronic storage 130 may be configured to electronically store information. Exemplary implementations of electronic storage that is the same or similar to electronic storage 130 are described further herein. The processor 132 may be configured to execute computer program modules. Exemplary implementations of processors that are the same or similar to processor 132 are described in connection with FIG. 2. The personal computing platform 108 may be configured to communicatively couple with treatment device 102 and/or other components of system 100. The personal computing platform 108 may be configured to receive, transmit, process, and/or store information related to one or more of pressure-based treatment, compressive force exerted on treatment device 102, and/or other information associated with system 100. According to some implementations, the computing platform 104 may include one or more of a personal computer, a laptop computer, a tablet computer, a Smart phone, a personal digital assistant (PDA), a gaming console, and/or other personal computing platforms.

The treatment platform server 110 may include one or more of electronic storage 134, at least one processor 136, and/or other components. The electronic storage 134 may be configured to electronically store information. Exemplary implementations of electronic storage that is the same or similar to electronic storage 134 are described further herein. The processor 136 may be configured to execute computer program modules. Exemplary implementations of processors that are the same or similar to processor 134 are described in connection with FIG. 2. The treatment platform server 110 may be configured to communicatively couple with treatment device 102 and/or other components of system 100. The treatment platform server 110 may be configured to receive, transmit, process, and/or store information related to one or more of pressure-based treatment, compressive force exerted on treatment device 102, and/or other information associated with system 100. In some implementations, treatment platform server 110 may be implemented by a cloud of computing platforms operating together as treatment platform server 110.

Electronic storage 126 of treatment device 102, electronic storage 130 of personal computing platform 108, and/or electronic storage 134 of treatment platform server 110 may comprise electronic storage media that electronically stores information. Such electronic storage media may include one or both of system storage that is provided integrally (i.e., substantially non-removable) with treatment device 102, personal computing platform 108, and/or treatment platform server 110. Electronic storage media may include removable storage that is removably connectable to treatment device 102, personal computing platform 108, and/or treatment platform server 110 via, for example, a port (e.g., a USB port, a firewire port, etc.) or a drive (e.g., a disk drive, etc.). Electronic storage 126, electronic storage 130, and/or electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 126, electronic storage 130, and/or electronic storage 134 may include one or more virtual storage resources (e.g., cloud storage, a virtual private network, and/or other virtual storage resources). Electronic storage 126, electronic storage 130, and/or electronic storage 134 may store software algorithms; information determined by one or more processors (e.g., processor 128, processor 132, and/or processor 136); information received from treatment device 102, user accessory 104, external resources 106, personal computing platform 108, and/or treatment platform server 110; and/or other information that enables system 100 to function as described herein.

FIG. 2 illustrates an exemplary processor 200 included in one or more components of system 100, in accordance with one or more implementations. The processor 200 may be the same or similar to processor 128 of treatment device 102, processor 132 of personal computing platform 108, and/or processor 136 of treatment platform server 110. Processor 200 is configured to provide information processing capabilities in system 100. As such, processor 200 may include one or more of a digital processor, an analog processor, a digital circuit designed to process information, an analog circuit designed to process information, a state machine, and/or other mechanisms for electronically processing information. Although processor 200 is shown in FIG. 2 as a single entity, this is for illustrative purposes only. In some implementations, processor 200 may include a plurality of processing units. These processing units may be physically located within the same device, or processor 200 may represent processing functionality of a plurality of devices operating in coordination.

As depicted in FIG. 2, processor 200 may be configured to execute one or more of a presentation module 202, a voice command module 204, a force quantification module 206, a position determination module 208, a treatment analysis module 210, a treatment coaching module 212, a backup module 214, an update module 216, and/or other computer program modules. Processor 200 may be configured to execute modules 202, 204, 206, 208, 210, 212, 214, 216, and/or other modules by software; hardware; firmware; some combination of software, hardware, and/or firmware; and/or other mechanisms for configuring processing capabilities on processor 200.

It should be appreciated that although modules 202, 204, 206, 208, 210, 212, 214, and 216 are illustrated in FIG. 2 as being co-located within a single processing unit, in implementations in which processor 200 includes multiple processing units, one or more of modules 202, 204, 206, 208, 210, 212, 214, and/or 216, may be located remotely from the other modules. For example, one or more of modules 202, 204, 206, 208, 210, 212, 214, 216, and/or other modules may be executed by processor 128 of treatment device 102, processor 132 of personal computing platform 108, and/or processor 136 of treatment platform server 110. The description of the functionality provided by the different modules 202, 204, 206, 208, 210, 212, 214, and/or 216 described below is for illustrative purposes, and is not intended to be limiting, as any of modules 202, 204, 206, 208, 210, 212, 214, and/or 216 may provide more or less functionality than is described. For example, one or more of modules 202, 204, 206, 208, 210, 212, 214, and/or 216 may be eliminated, and some or all of its functionality may be provided by other ones of modules 202, 204, 206, 208, 210, 212, 214, and/or 216. As another example, processor 200 may be configured to execute one or more additional modules that may perform some or all of the functionality attributed below to one of modules 202, 204, 206, 208, 210, 212, 214, and/or 216.

The presentation module 202 may be configured to present, via user interface 120, information associated with system 100. Such information may be presented visually, audibly, textually, haptically, and/or other presentation manners. According to some implementations, presentation module 202 may be configured to present information derived from a force output signal provided by force sensor 112, information derived from a position output signal provided by position sensor 114, information associated with pressure-based treatment, and/or other information associated with system 100.

The voice command module 204 may be configured to receive voice commands and initiate corresponding operations based on the received voice commands. In some implementations where user interface 120 of treatment device 102 includes a microphone, voice command module 204 may be configured to receive audio information captured by the microphone that includes a voice command. The voice command module 204 may be configured to initiate, responsive to reception of the audio information including the voice command, an operation by the one or more processors (e.g., processor 200) corresponding to the voice command in the received audio information. The voice command module 204 may utilize one or more of speech recognition, speech to text, and/or other voice-based technologies. The voice command module 204 may be configured to identify a speaker based on the speaker's voice.

The force quantification module 206 may be configured to quantify a force exerted on a body part of the subject. The force may be quantified based on a signal conveying information associated with the exerted force (e.g., the force output signal generated by force sensor 112). Quantifying the force may include quantifying one or more of a magnitude of force, a duration of force, a force magnitude profile as a function of time, a quantity of compressive forces, and/or other quantifiable information associated with forces exerted on the body of the subject.

The position determination module 208 may be configured to identify the body part of the subject on which a force is applied. The position determination may be based on a signal conveying information associated with the position of treatment device 102 relative to the body of the subject (e.g., the position output signal generated by position sensor 114). By way of non-limiting example, position determination module 208 may determine that a force was applied (by way of treatment device 102) to a rhomboid, trapezius, or other muscle group of the subject. The position determination module 208 may be configured to determine position and a function of time.

The treatment analysis module 210 may be configured to determine one or more parameters associated with the pressure-based treatment. Examples of such parameters may include one or more of a duration of the exerted force, a duration of a treatment session, a type of pressure-based treatment, a direction of a motion, a rate of a motion, a force gradient, a force magnitude, a pattern of one or more parameters (e.g., motions, magnitudes, durations, and/or other parameters), and/or other parameters associated with the pressure-based treatment.

The treatment coaching module 212 may be configured to provide one or more instructions associated with the pressure-based treatment. A given instruction may relate to one or more of a magnitude of the exerted force, a position on the body of the subject where the force is to be applied, and/or other aspects of a pressure-based treatment. Instructions may be conveyed one or more of audibly, visually, textually, haptically (e.g., by vibration and/or other haptic feedback), and/or in other manners. Instructions may be stored in system 100 (e.g., at electronic storage 126, electronic storage 130, electronic storage 134, and/or other locations). The instruction may be provided as a series of lessons on pressure-based treatment. In some implementations, instructions may be provided by a remote source. For example, instructions may be provided by a remotely located instructor. The treatment coaching module 212 may be configured to provide feedback associated with a pressure-based treatment that is being performed and/or that was performed in the past. Such feedback may comprise a critique of the pressure-based treatment.

The backup module 214 may be configured to back up information stored by treatment device 102. Information stored by treatment device 102 may be transmitted to a remote electronic storage configured to electronically store information (e.g., electronic storage 130 of personal computing platform 108 and/or electronic storage 134 of treatment platform server 110). The backup module 214 may be configured to perform a backup according to a schedule, responsive to a command received from a user, responsive to information being stored by treatment device 102, responsive to treatment device 102 becoming communicatively coupled with personal computing platform 108 and/or personal wellness platform server 110, and/or based on other criteria.

The update module 216 to manage updates of software and/or firmware of treatment device 102. Software updates and/or firmware updates may be transmitted from personal computing platform 108, treatment platform server 110, and/or other components of system 100. Software updates and/or firmware updates may be received by treatment device 102. Software updates and/or firmware updates may be implemented on processor 128 and/or other components of treatment device 102.

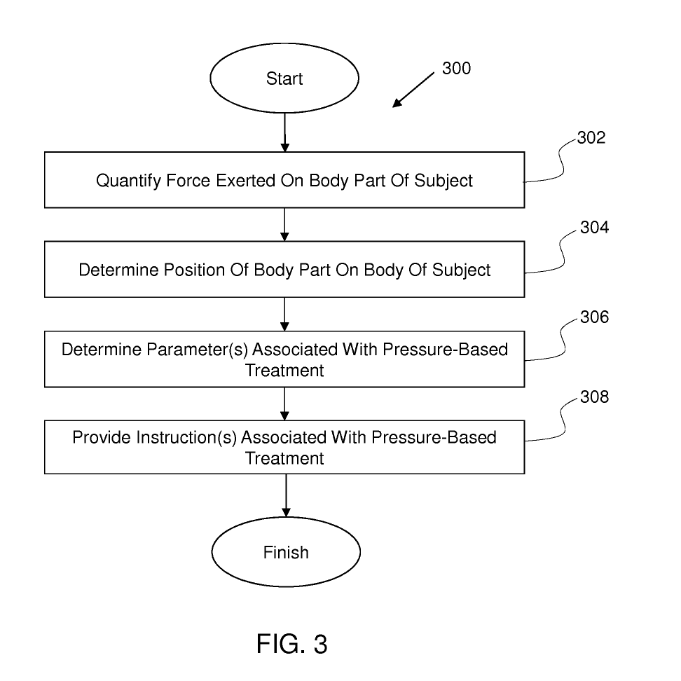

FIG. 3 illustrates a method 300 for facilitating coaching and/or analysis of pressure-based treatment, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At an operation 302, a force exerted on a body part of a subject may be quantified. The force may be quantified based on a signal conveying information associated with the exerted force. The force may be exerted by a force exerting object on one or more housing bodies of a treatment device (e.g., treatment device 102) disposed between the force exerting object and the body part of the subject. The force may be applied as the pressure-based treatment. Operation 302 may be performed by one or more processors configured to execute a force quantification module that is the same as or similar to force quantification module 206, in accordance with one or more implementations.

At an operation 304, a position of the body part on the body of the subject may be determined. The position may be determined based on a signal conveying information associated with the position of the treatment device relative to the body of the subject. Operation 304 may be performed by one or more processors configured to execute a position determination module that is the same as or similar to force position determination module 208, in accordance with one or more implementations.

At an operation 306, one or more parameters associated with the pressure-based treatment may be determined. Operation 306 may be performed by one or more processors configured to execute a treatment analysis module that is the same as or similar to treatment analysis module 210, in accordance with one or more implementations.

At an operation 308, one or more instructions associated with the pressure-based treatment may be provided. A given instruction may relate to one or both of a magnitude of the exerted force or a position on the body of the subject where the force is to be applied. Operation 308 may be performed by one or more processors configured to execute a treatment coaching module that is the same as or similar to treatment coaching module 212, in accordance with one or more implementations.

In some implementations, treatment device 102 may promote personal wellness by determining and/or evaluating aspects of personal health and/or exercise. By way of non-limiting example, aspects of personal health may include vital signs, trends in personal fitness, frequency of exercise, and/or other aspects of personal health, while aspects of personal exercise may include number of repetitions, calories burnt, duration of exercise, and/or other aspects of personal exercise. In some implementation, the treatment device 102 may facilitate personal wellness management, as described in U.S. patent application Ser. No. 13/527,401, filed on Jun. 19, 2012, and entitled “Personal Wellness Management Via a Personal Exercise Device,” which is incorporated herein by reference.

According to some implementations, treatment device 102 may be configured to facilitate interpersonal communications, such as voice over internet protocol, short message service, multimedia messaging service, video conferencing, telephony, and/or other interpersonal communications. The treatment device 102 may facilitate socializing and/or merchandizing, according to some implementations, as described in U.S. patent application Ser. No. 13/527,437, filed on Jun. 19, 2012, and entitled “Socializing, Merchandizing, and/or Gaming Via a Personal Exercise Device and/or a Personal Wellness Platform,” which is incorporated herein by reference.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A treatment device configured to facilitate coaching and/or analysis of pressure-based treatment, the treatment device comprising:
one or more housing bodies configured to be disposed between a body part of a subject and a force exerting object such that a force exerted by the force exerting object is conveyed to the body part of the subject via the one or more housing bodies, the force being applied as the pressure-based treatment; and
one or more processors configured to execute computer program modules, the one or more processors being housed by the one or more housing bodies, the computer program modules comprising:
a force quantification module configured to quantify the force exerted on the body part of the subject based on a signal conveying information associated with the exerted force; and
a treatment analysis module configured to determine one or more parameters associated with the pressure-based treatment.

2. The treatment device of claim 1, wherein the force exerting object is one or more of a hand of a treatment provider, a foot of the treatment provider, an accessory manipulated by the treatment provider, a hand of the subject, or an accessory manipulated by the subject.

3. The treatment device of claim 1, wherein the computer program modules further comprise a position determination module configured to identify the body part of the subject based on a signal conveying information associated with the position of the treatment device relative to the body of the subject.

4. The treatment device of claim 1, wherein the computer program modules further comprise a treatment coaching module configured to provide one or more instructions associated with the pressure-based treatment, a given instruction relating to one or both of a magnitude of the exerted force or a position on the body of the subject where the force is to be applied.

5. The treatment device of claim 4, wherein the one or more instructions are conveyed one or more of audibly, visually, textually, or haptically.

6. The treatment device of claim 1, wherein the one or more parameters associated with the pressure-based treatment include one or more of a duration of the exerted force, a duration of a treatment session, a type of pressure-based treatment, a direction of a motion, a rate of a motion, or a force gradient.

7. The treatment device of claim 1, further comprising a force sensor configured to generate a force output signal that conveys information related to compressive force exerted on the treatment device.

8. The treatment device of claim 1, further comprising a position sensor configured to generate a position output signal conveying information related to a position of the treatment device relative to the body of the subject.

9. The treatment device of claim 1, further comprising an actuator configured to provide vibrational therapy to the subject by vibrating the treatment device.

10. The treatment device of claim 1, further comprising an electrical muscle stimulation interface configured to removably couple the treatment device with an electrode, the electrode being configured to provide electrical muscle stimulation to a user

11. The treatment device of claim 1, wherein the one or more housing bodies comprise a first housing body and a second housing body, the first housing body and the second housing body being movably coupled together by way of a coupling mechanism such that the two housing bodies are reconfigurable between an open configuration and a closed configuration, the two housing bodies being configured to receive compressive force during pressure-based treatment while in the closed configuration.

12. The treatment device of claim 11, further comprising a user interface accessible with the two housing bodies in the open configuration, the user interface being configured to receive information from a user and provide information to the user.

13. The treatment device of claim 1, further comprising a communications apparatus configured to receive information and/or transmit information from the treatment device.

14. The treatment device of claim 10, wherein the communications apparatus includes one or both of a wireless communications interface or a wired communications interface.

15. The treatment device of claim 10, wherein the communications apparatus is configured to communicatively couple the treatment device with a user accessory, the user accessory being separate and distinct from the treatment device.

16. The treatment device of claim 10, wherein the communications apparatus is configured to communicatively couple the treatment device with a computing platform configured to receive and process information related to the pressure-based treatment.

17. A method for facilitating coaching and/or analysis of pressure-based treatment, the method comprising:
quantifying, with one or more processors, the force exerted on a body part of a subject based on a signal conveying information associated with the exerted force, the force being exerted by a force exerting object on one or more housing bodies of a treatment device disposed between the force exerting object and the body part of the subject, the force being applied as the pressure-based treatment; and
determining, with one or more processors, one or more parameters associated with the pressure-based treatment.

18. The method of claim 17, wherein the force exerting object is one or more of a hand of a treatment provider, a foot of the treatment provider, an accessory manipulated by the treatment provider, a hand of the subject, or an accessory manipulated by the subject.

19. The method of claim 17, further comprising determining, with one or more processors, a position of the body part on the body of the subject based on a signal conveying information associated with the position of the treatment device relative to the body of the subject.

20. The method of claim 17, further comprising providing, with one or more processors, one or more instructions associated with the pressure-based treatment, a given instruction relating to one or both of a magnitude of the exerted force or a position on the body of the subject where the force is to be applied.
